(19) United States
(12) Patent Application Publication
(10) Pub. No.: US 2015/0100331 A1
(43) Pub. Date: Apr. 9, 2015

(54) BUSINESS INTELLIGENCE SYSTEM AND SERVICES FOR PAYOR IN HEALTHCARE INDUSTRY

(71) Applicant: Joydeep Roychowdhury, Powell, OH (US)

(72) Inventor: Joydeep Roychowdhury, Powell, OH (US)

(21) Appl. No.: 14/048,070

(22) Filed: Oct. 8, 2013

(51) Int. Cl. G06Q 50/22; G06Q 10/10

(52) U.S. Cl. CPC G06Q 50/22; G06Q 10/10
USPC 705/2

(57) ABSTRACT

A business intelligence solution tailored to health care services. Specifically, the present invention consists at least one Payor source as enterprise resource planning (ERP)/legacy engine integrated with plurality of data; a extract transform and load (ETL) engine designed for extracting data from said Enterprise resource planning (ERP)/legacy engine consisting of business metrics relating to performance of the business with its organized data in hierarchy; at least one LANDING PAD/staging layer having at least one staging data table; at least one analytic engine called STAR SCHEMA designed for reporting, analysis and planning of information based on business metric implemented; at least one TRANSACTIONA DATA MODEL for transforming data from said Payor source into web interface; designed to support business analytic activities such as healthcare data, financial data and business administration.

### FIELD OF THE INVENTION

The present invention is related to health care analytics system and services. More particularly the present provides business intelligence system and services for Payor in healthcare industry.

### BACKGROUND OF THE INVENTION

The increasing costs of health care services and the large data of healthcare services create a challenge for Payors including both private and public Payors that are looking to manage and to control these costs and data. Health care organizations, typically, include Payor and members enrolled for a health plan in the health care organization. The operations of a health care organization depend on one or more factors including the number of members enrolled for the health plans, performance of the health care providers, quality of service provided by the health care providers to the enrolled members, management and utilization of the resources of the health care organization, etc. For maintaining quality of service in the health care organization, the performance of the Payor needs to be monitored periodically. Furthermore, for improving quality in the healthcare organization, the Payor needs to be engaged and motivated for improving their performance.

In today's healthcare environment, organizations are swimming in an ever-deeper pool of data yet many lack the technology to use this data as valuable information. As regulations change and the amount of data increases, organizations are turning to business intelligence (BI) solutions to harness data for precise decision-making to help improve patient outcomes, reduce costs, and ensure their organization's future.

Decisions regarding the healthcare of an individual are often made by a healthcare team of individuals, physicians, and organizations. In order to make the proper decisions, a healthcare team must rely on a variety healthcare data records, and each of the healthcare data records may include different information. A drawback of providing a variety of disparate healthcare data records to the healthcare team members is that they may not be able to interpret all the disparate data or the ability to display it in one unified way. As a consequence, providing all the healthcare data records directly to the healthcare team members leads to additional administrative expenses to sift through disparate healthcare data records and identify the healthcare data records that each member can interpret. In some instances, the lack of coordinated data can compromise the health and wellbeing of patients.

For an enterprise to be competitive, the ability to perform analysis on large amount of data is very important to analyze a trend, discover the points, and/or discover new opportunities. Most companies today implement various Business Performance Management solutions including Business Intelligence techniques that help determine the current state of the business. This is achieved by defining metrics or key performance indicators organized in a hierarchy through the various vertical and horizontal silos of the organization. Data and events received in real time are persisted in a data mart and are used to provide historical analysis summarizing what has happened in the past. This kind of traditional analysis cannot reveal what will happen in the future. Business process monitoring models currently lack the ability to incorporate all the data, which restricts the models' ability to capture such metrics.

Data mining tools provide scoring models and predictions based on historical data; however, data mining tools do not provide metric values but can determine qualitative relationships. System dynamics use continuous modeling to predict values of metrics based on the specified time dimension; however, system dynamics is subjective since it is based on the user's perception of the metric network and relationships.

The integration of these predictive modeling with standard business process monitoring and management systems has always been a challenge. Business monitoring systems are built using metrics catering to the current and in some cases historical aspects of the business whereas predictive models look ahead in time.

Several companies have begun to provide healthcare analytic and warehousing services to the healthcare industry. Examples of such companies include IMS Health, Inc., Health Care DataWorks, Inc, eHealthPartners, Catalyst Solutions, The TriZetto® Group, Inc. (TriZetto) etc. The analytic efforts of these companies have significant limitations. These limitations are due, in part, to their failure to successfully address a number of factors including: Health information is diverse, complex, and is not homogeneous; the architecture and composition of the analytic data stores are critical to the successful application of data mining tools; the analyst requires the ability to interactively refine the analytic model as part of the analytic process.

In general, the various data sources used by a healthcare environment to manage its assets are heavily customized to that particular environment, preventing the rapid development of applications that can be used across varying types of data sources. In such a situation, the execution of an application utilizing data from each of these different departments may be impossible or impractical because the data sources are so heavily customized. This problem may be even more apparent for enterprises that include multiple independent healthcare environments. However, converting all of these disparate data sources into a single format that will support such application development and execution is both impractical and overly expensive for most healthcare environments and enterprises.

One of the major challenges facing healthcare IT today is that of explosive data growth. A number of different factors have begun contributing to an unprecedented increase in the volume of information handled by healthcare data storage infrastructure. This has led healthcare organizations to look for new and creative ways to accommodate massive amounts of data without breaking the bank in the process.

The problem of exponential data growth isn't unique to healthcare organizations. General purpose IT shops have been dealing with this challenge for decades. Even so, there are several factors that are unique to healthcare IT that have caused healthcare-related data growth to outpace that of most other types of organizations.

Increasing regulatory pressures on healthcare organizations, an advance systems and services for Payor in healthcare industry have been developed for providing an easily accessible and accurate means by which consumers, purchasers, and providers of healthcare can differentiate and evaluate the quality of healthcare providers and plans. It is designed for healthcare organizations especially for Payors dipping their toes into the areas of business intelligence and data warehousing.

### SUMMARY OF THE INVENTION

The present invention encompasses a set of analytics and data warehousing tools and services that incorporate proprietary analytic structures and metrics. The present invention is a business intelligence solution tailored to health care services. Specifically, the present invention consists at least one Payor source as enterprise resource planning (ERP)/legacy engine integrated with plurality of data; a extract transform and load (ETL) engine designed for extracting data from said Enterprise resource planning (ERP)/legacy engine consisting of business metrics relating to performance of the business with its organized data in hierarchy; at least one LANDING PAD/staging layer having at least one staging data table; at least one analytic engine called STAR SCHEMA designed for reporting, analysis and planning of information based on business metric implemented; at least one TRANSACTIONA DATA MODEL for transforming data from said Payor source into web interface; designed to support business analytic activities such as healthcare data,financial data and business administration.

The present invention provides across a wide variety of healthcare data with a minimal amount of customization beyond the basic extract, transform, and load (ETL) process.

One embodiment of the present invention a system for providing analytics and data warehousing to allow business intelligence performance management of healthcare, the system comprises; at least one Payor source as enterprise resource planning (ERP)/legacy engine integrated with plurality of data; a extract transform and load (ETL) engine designed for extracting data from said Enterprise resource planning (ERP)/legacy engine consisting of business metrics relating to performance of the business with its organized data in hierarchy; at least one LANDING PAD/staging layer having at least one staging data table; at least one analytic engine called STAR SCHEMA designed for reporting, analysis and planning of information based on business metric implemented; at least one TRANSACTIONA DATA MODEL for transforming data from said Payor source into web interface; Wherein said system provides useful information for making decision, managing business and predicting future plans.

An advantage of the present invention is an information technology solution to analysis of healthcare data, and specifically addresses issues related to health care services and administrations. This allows the healthcare industry specially Payor to extract analytic data from data source by providing an easily accessible and accurate means by which consumers, purchasers, and providers of healthcare can differentiate and evaluate the quality of healthcare providers and plans.

### BRIEF DESCRIPTION OF THE DRAWINGS

The following invention will be described with reference to the following drawings of which:

FIG. 1 illustrates a system for providing analytics and data warehousing to allow business intelligence performance management of healthcare, in which various embodiment of the present invention may be practiced.

FIG. 2 is a high level schematic diagram of the functional characteristics of the system for providing analytics and data warehousing to allow business intelligence performance management of healthcare, in which various embodiment of the present invention may be practiced.

FIG. 3 is a schematic diagram of an exemplary preferred embodiment of the system of the present invention showing user access and flow of information out of the system.

FIG. 4 is a flow chart illustrating a method for providing analytics and data warehousing to allow business intelligence performance management of healthcare, in which various embodiment of the present invention may be practiced.

FIG. 5 is a flow chart illustrating a method for a method for providing business intelligence performance management of healthcare.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

The present invention encompasses a set of analytics and data warehousing tools and services that incorporate proprietary analytic structures and metrics. The present invention is a business intelligence solution tailored to health care services. Specifically, the present invention consists at least one Payor source as enterprise resource planning (ERP)/legacy engine integrated with plurality of data; a extract transform and load (ETL) engine designed for extracting data from said Enterprise resource planning (ERP)/legacy engine consisting of business metrics relating to performance of the business with its organized data in hierarchy; at least one LANDING PAD/staging layer having at least one staging data table; at least one analytic engine called STAR SCHEMA designed for reporting, analysis and planning of information based on business metric implemented; at least one TRANSACTIONA DATA MODEL for transforming data from said Payor source into web interface; designed to support business analytic activities such as healthcare data,financial data and business administration.

The present invention provides across a wide variety of healthcare data with a minimal amount of customization beyond the basic extract, transform, and load (ETL) process.

One embodiment of the present invention a system for providing analytics and data warehousing to allow business intelligence performance management of healthcare, the system comprises; at least one Payor source as enterprise resource planning (ERP)/legacy engine integrated with plurality of data; a extract transform and load (ETL) engine designed for extracting data from said Enterprise resource planning (ERP)/legacy engine consisting of business metrics relating to performance of the business with its organized data in hierarchy; at least one LANDING PAD/staging layer having at least one staging data table; at least one analytic engine called STAR SCHEMA designed for reporting, analysis and planning of information based on business metric implemented; at least one TRANSACTIONA DATA MODEL for transforming data from said Payor source into web interface; Wherein said system provides useful information for making decision, managing business and predicting future plans.

The present invention is directed to Analytics and data warehousing to allow business intelligence performance management of healthcare, the system provides a way to extract data from Payor source as enterprise resource planning (ERP)/legacy engine includes but not limited to GL, CL (claims adjudication), PR (provider), ME (member), HR(health record), CC (Call center),CM (Care/Case Management), feeds and sources.

The term “data” is used to describe stored information. For clarity, the data used by the invention has been divided into three separate categories: Payor source, staging data table, and analytic data stores. Payor source as enterprise resource planning (ERP)/legacy engine includes but not limited to GL, CL (claims adjudication), PR (provider), ME (member), HR(health record), CC (Call center),CM (Care/Case Management), feeds and sources.

The staging data tables which are relational data in a uniform database environment are then used by the transactional data model. Exemplary individual tables found in the staging data table might include: healthcare services Encounters and Procedures.” The transactional data model creating new variables from the source data and restructuring the data for analysis as an analytic data. More specifically, the transactional data model provides for the partial denormalization (summarization) of staging data tables to the modified star schema of the present invention's analytic data warehouse. Exemplary individual analytic data tables found in the analytic data tables are filled with analytic data elements.

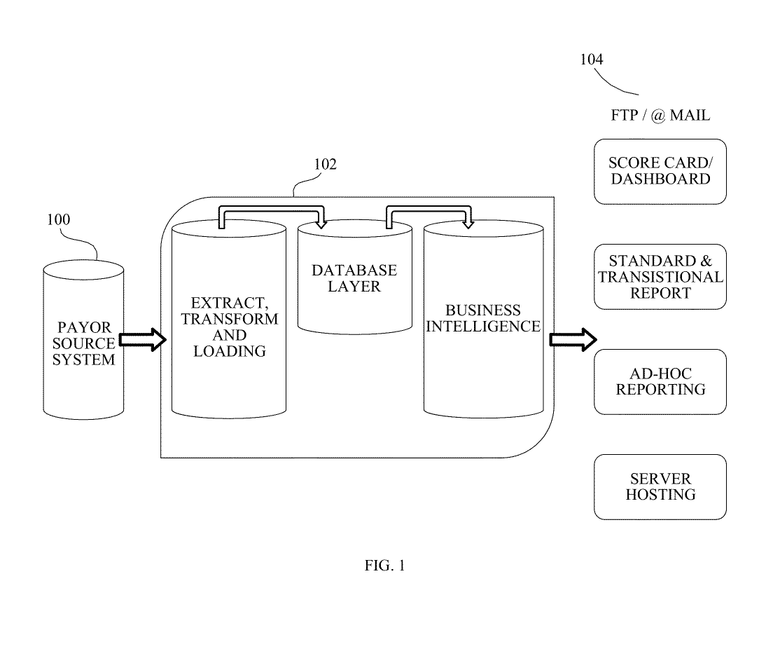

FIG. 1 illustrates system for providing analytics and data warehousing to allow business intelligence performance management of healthcare. The system includes a Payor source (100) as an enterprise resource planning (ERP)/legacy engine integrated with polarity of data, a extract transform and load (ETL) engine designed for extracting data from said Enterprise resource planning (ERP)/legacy engine, a database layer for storing data, a business intelligence includes business metrics combined as a whole (102), and processed data are transferred into web interface (104) comprises scorecard/dashboard, standard and transactional report, AD-HOC reporting's, server hosting s services etc.

The user end reporting's in communication with the business intelligence metrics. Additionally, the user end reporting's in communication with the database layer.

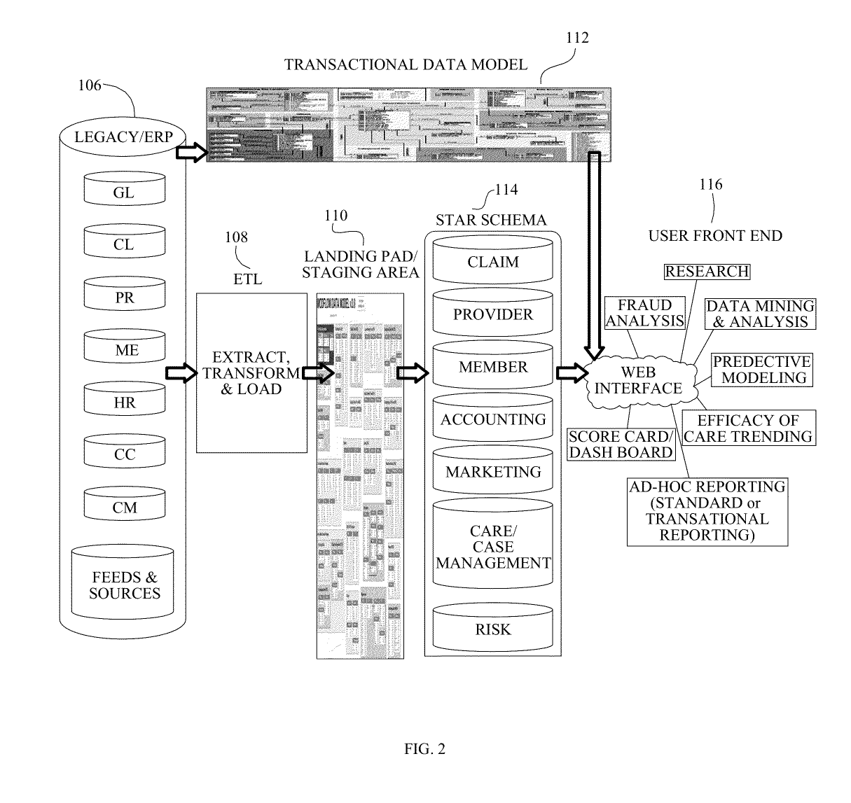

FIG. 2 shows an exemplary embodiment of the present invention. As shown, input into the system may come from any type of Payor source as enterprise resource planning (ERP)/legacy engine (106) includes but not limited to GL, CL (claims adjudication), PR (provider), ME (member), HR(health record), CC (Call center),CM (Care/Case Management), feeds and sources. A extract transform and load (ETL) engine (108) designed for extracting data from said Enterprise resource planning (ERP)/legacy engine. Information or data from these source data is extracted for use in the business intelligence analytics. The present invention extracts and loads the source data into staging data tables on landing pad or staging area (110) which are then used by the star schema (114). The transactional data model (112) interrogates the staging data tables, creating new variables from the source data and restructuring the data for analysis. The product of the star schema is an analytic data warehouse. A web interface (116) on user front end is used to create ad hoc reporting, data mining, predictive modeling, fraud analysis, efficacy of care trending, research, score care/dashboard and generate data exports or allow for interactive analysis.

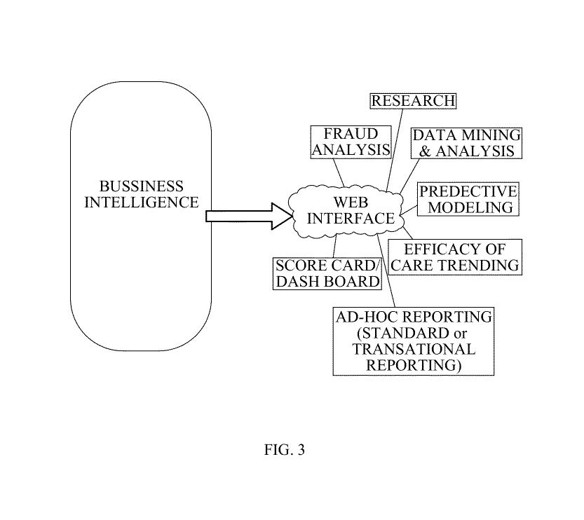

FIG. 3 shows a schematic diagram of an exemplary preferred embodiment of the system of the present invention showing user access and flow of information out of the system.

Another embodiment of the present invention provide a system for providing healthcare analytics and data warehousing to allow business intelligence performance management comprising a database layer, Payor source as service component layer, and star schema as a service application layer. The database layer is adapted to preprocess healthcare intelligence data. The Payor source is adapted to comprise a plurality of service components or source data. The star schema as service application layer is adapted to comprise business metrics service application. The healthcare analytics and data warehousing to allow business intelligence data is data related to management of healthcare data. The system is configured according to a service-oriented architecture and uses service-oriented computing. The system is adapted to utilize at least one of the pluralities of source data to provide the healthcare business intelligence.

One another embodiment of the invention is an analytics and data warehousing to allow business intelligence performance management of healthcare services and method, the method comprising: generating a Payor source system as enterprise resource planning (ERP) /legacy engine integrated with plurality of data; extracting data from said Payor source by a extract transform and load (ETL) engine; populating at least one staging data table on landing pad/staging area with said data; transforming data from said staging data table into STAR SCHEMA for analysis which include business performance metrics; implementing metrics for analyzing in STAR SCHEMA; supporting and analyzing to user on user front end via web interface with ad hoc reporting, data mining, predictive modeling, fraud analysis, efficacy of care trending, research, score care/dashboard, said star schema engine facilitating user independent definition and user generation of user defined query concepts; and generating analysis and reports on user front end by web interface.

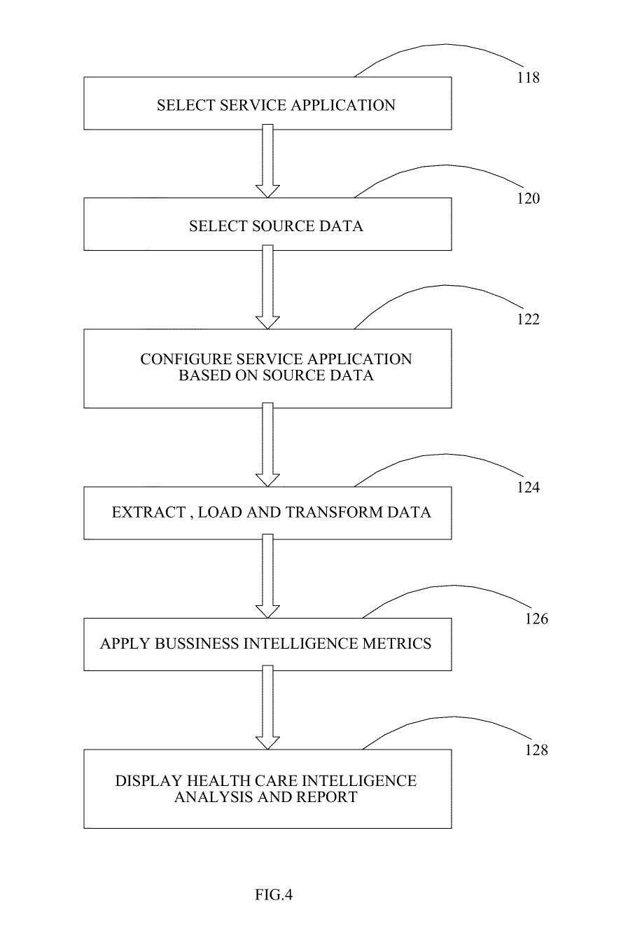

FIG. 4 is a flow chart illustrating a method for providing analytics and data warehousing to allow business intelligence performance management of healthcare, the method includes the following steps, which will be described below in more detail. At step (118), a service application is selected. At step (120), one or more service components or source data's are selected. At step (122), the service application is configured based at least in part on the one or more service components or source data selected. At step (124), the service components or source is extracted from Payor source by a extract transform and load (ETL) engine acquire healthcare business intelligence data, the data is preprocessed by applying business metrics. At step (126), the healthcare intelligence data is organized. One or more rules are applied to the healthcare business intelligence data. The healthcare intelligence data is processed. At step (128), the healthcare business intelligence is generated based at least in part on the processing of the healthcare intelligence data and display health care intelligence analysis and report.

Payor industries generate source data in many different ways, often with different systems. To accommodate a variety of source data environments (e.g. ORACLE®, SAS Institute Inc.'s SAS™, SYBASE Inc.'s SYBASE®, IBM Corporation's DB2®, Microsoft Corporation's MICROSOFT ACCESS®, and Microsoft Corporation's MICROSOFT EXCEL™), the present invention can preferably extract or receive data from any source data that is compliant with open database connectivity (ODBC) standards which is an industry-standard interface that makes it possible to access different database systems with a common language, SQL compliant data stores, or any application capable of producing business intelligence system.

The present invention transforms data, creates new variables from the source data and stores them in the staging data tables, and then restructures the data making it both ready and available for analysis as analytic data. Through these method, the transformation data model provides for the partial denormalization (summarization) of staging data tables to the modified star schema (dimensional) organization of the present invention's analytic data warehouse; incorporating an understanding of the administration and financial as well as the operational domain of healthcare.

In yet one another embodiment of the present invention, the method further comprises steps selected from the group consisting of: performing transformation algorithms; creating derived variables; restructuring data; updating analytic; creating business performance metric; and outputting information to a user through web interface based, in part, on the analysis.

One another embodiments of the present invention provide healthcare business intelligence including selecting a service component from a plurality of service components and configuring a service application based at least in part on the selected service component using service-oriented computing. The plurality of service components is in a service-oriented architecture. The service component is adapted to acquire healthcare asset intelligence data from a data warehouse. The service application is adapted to generate the healthcare business intelligence using the selected service component.

In on another embodiment of the present invention a method for providing predictive modeling capabilities to allow intelligent business performance management of a business comprising the steps of: generating, using at least one computer, ERP/LEGACY consisting of business metrics relating to performance of the business as a hierarchy across operational and strategic levels of the business with each; a strategic level of the business comprising strategic metrics having a relationship with transsactional data model and star schema; transforming, transformation data model, the data source into performance warehouse star schemas without losing persistence of historical data related to the performance of the business; and using a computer, receiving requests for metric predictions and servicing the requests in real time, wherein said STAR SCHEMA context to be used as input for business performance analysis.

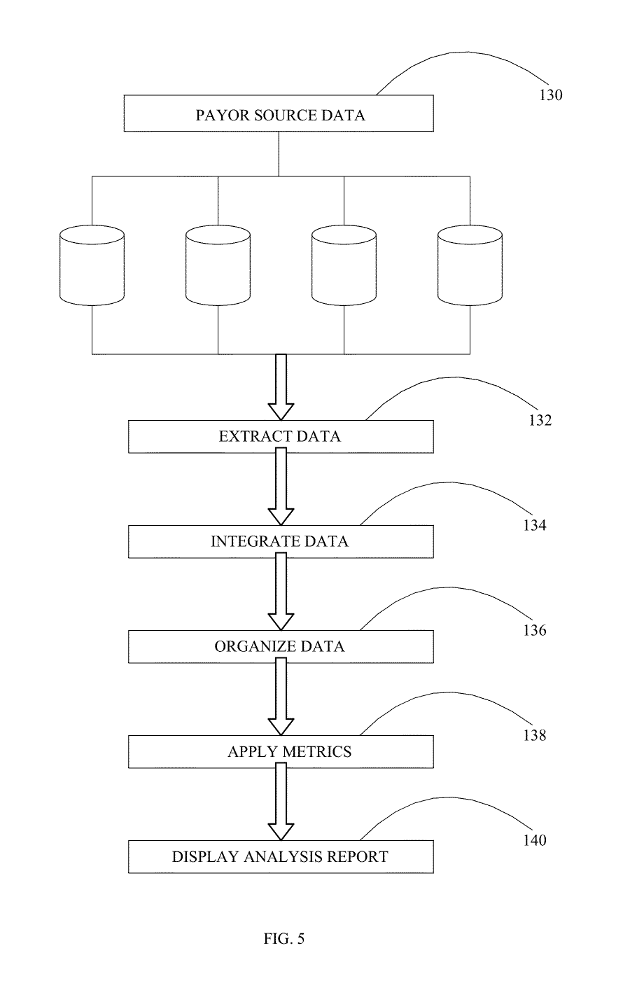

FIG. 5 is a flow chart illustrating a method for providing healthcare business intelligence in accordance with an embodiment of the present invention. At step (130) Payor source is extracted by a extract transform and load (ETL) engine. At step (132) the service application is configured based at least in part on the one or more data extracted. At step (134) the data is integrated for the preprocess to the enterprise processor, which applies metrics to the data. At step (136), the one or more service components acquire healthcare intelligence metric. (138) the acquired healthcare asset intelligence data is processed and organized. At the end (140), healthcare intelligence report is generated onto user front end based at least in part on the processing.

The enterprise processer provides business intelligence metrics with rules regarding, for example, enterprise-wide policies or procedures.

In one another embodiment of the present invention a method of providing healthcare intelligence and analytics, comprising: receiving a plurality of sets of data from Payor source; matching at least one data from each set of the sets of data to each of a plurality business performance; identifying a healthcare data from at least one of the sets of healthcare data records that is relevant to a target query; analyzing the result of associating query; and outputting information to user from web interface in part of the analysis. Wherein business intelligence performance management of healthcare services also includes receiving insurance claims data as input and predicting individual usage of healthcare services over a next insured period and predicting future plans.

In one another embodiment of the present invention provides a business intelligence appliance, comprising: hardware memory for storage; and a processor coupled to the hardware memory, in which the processor is configured to execute the steps comprising: receiving a plurality of sets of healthcare data records; extracting data record by ETL; matching at least one healthcare data record from each set of the sets of healthcare data records; transforming data record by transactional data model by using business metrics; identifying a healthcare data record from at least one of the sets of healthcare data records that is relevant to a target; analyzing the result of associating each data of the plurality of data with at least one healthcare data record from at least one set of healthcare data records and the result of identifying the health care data record relevant to the target data; and outputting information to web interface on user front area, in part, on the analysis.

The present invention provides an information technology solution to analysis of healthcare data, and specifically addresses issues related to health care services and administrations. This allows the healthcare industry specially Payor to extract analytic data from data source by providing an easily accessible and accurate means by which consumers, purchasers, and providers of healthcare can differentiate and evaluate the quality of healthcare providers and plans.

Certain embodiments of the present invention provide a method for providing healthcare business intelligence including acquiring healthcare intelligence data from a data warehouse using at least one service component, processing the acquired healthcare asset intelligence data using the at least one service component in a service-oriented architecture, and generating the healthcare asset intelligence based at least in part on the processing of the acquired healthcare asset intelligence data using service-oriented computing.

Certain embodiments of the present invention provide a computer-readable medium including a set of instructions for execution on a computer including a data acquisition routine, a processing routine, and an intelligence generation routine. The data acquisition routine is configured to acquire healthcare business intelligence data. The processing routine is configured to process the acquired healthcare business intelligence data based at least in part on a service application using a service-oriented architecture. The intelligence generation routine is configured to generate healthcare asset intelligence based at least in part on the processing routine using service-oriented computing and the service-oriented architecture.

Certain embodiments of the invention provide a method that may utilize data sets from different data sources in their existing format and provide the ability to construct service applications and/or decision-making applications using versatile service components in order to provide healthcare asset intelligence. The healthcare business intelligence may include managing or making decisions concerning the healthcare data in an enterprise. Moreover, certain embodiments provide an architecture that facilitates the rapid and inexpensive creation of service applications but still ensures the integrity of data being accessed by the service components of a given service application. Certain embodiments of the present invention are utilization-based, which may help enable the utilization of applications without guessing and/or estimating healthcare data.

Certain embodiments of the present invention provide architecture, methods, and processes for providing healthcare business intelligence. Certain embodiments allow for optimal utilization of healthcare data and/or scheduling of the healthcare data based on utilization. Certain embodiments allow for a comparison of utilizations between different enterprise sub-groups. Certain embodiments of the present invention provide visibility of all the healthcare data at an enterprise level.

In operation, the system is configured according to a service-oriented architecture and uses service-oriented computing. The data layer preprocesses healthcare business intelligence data. The service component layer includes a plurality of service components, wherein each of the plurality of service components utilizes the healthcare asset intelligence data. The service application layer includes a service application that utilizes at least one of the pluralities of service components to provide healthcare asset intelligence.

The healthcare data may include information that may be useful in generating the healthcare business intelligence, such as deciding how to manage healthcare. Information that may be useful in managing those data may relate to demand for, access to, and use of the healthcare data in an enterprise.

The service components, data, and/or functionality of the web interface and system described above may be implemented alone or in combination in various forms of hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

In certain embodiments, the first integrated data source and the second integrated data source may be located remotely from one another and/or in the same network. In addition, one or more of the units comprising the first set of data sources or the second set of data sources may be located remotely from one another. In certain embodiments, the data warehouse is part of a centralized site that may be located, for example, in a back office or at a particular location within an enterprise. In certain embodiments, the data storage environment may also include relational databases and/or hierarchical databases.

In certain embodiments, the data warehouse may be in communication with a plurality of integrated data sources which are each in communication with one or more data sources.

The data analytics is in communication with the preprocessor unit, the business data source, the device scheduler, the financial, administration, the dashboard, the user interface, the software management unit, and the centralized site. The centralized site is in communication with the back office.

The star schema may perform data reduction by either horizontal or vertical reduction, generalization of lower level concepts to higher level, summarization of the data, or transforming to the higher level of concepts. The star schema may allow the reduction of data without losing much information entropy. The star schema may also provide abstraction to all the healthcare business intelligence data in various formats by converting them into a common data format. This consistent format may prepare the data for easy and efficient analysis when needed.

The system may be created using existing data sources, which may comprise the data layer, and existing service components, which may comprise the service component layer. The existing service components may be selected and/or integrated for a particular service application. The service application may query one or more of the existing service components for information related to healthcare business intelligence.

The plurality of service components may be in a service-oriented architecture. Each service component may be adapted to acquire healthcare intelligence data from a data warehouse, such as the data warehouse.

A system for providing analytics and data warehousing to allow business intelligence performance management of healthcare through three different layers: Performance management for quickly and easily create dashboards and scorecards, so that everyone can align with departmental and organizational goals, with reporting and analysis tools and technologies that will help capture the structured and unstructured information they use to make decisions and Data warehouse get insight into the data you need through an integrated, centrally managed, and trusted data source. The present invention provides an enterprise-ready BI platform with SQL Server. User can combine data from multiple sources into one location and provide access to information from a unified, trusted database, using SQL Server as data warehouse.

As described above, the order in which the one or more service components acquire healthcare asset intelligence data may be regulated in order to maintain the data's integrity. Each service component may retrieve healthcare asset intelligence data from a data layer, which may be similar to the data layers.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN), which are presented here by way of example and not limitation. Such networking environments are commonplace in office-wide or enterprise-wide computer networks, intranets, and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

What is claimed is:

1. A system for providing analytics and data warehousing to allow business intelligence performance management of healthcare, the system comprises:
at least one Payor source as enterprise resource planning (ERP)/legacy engine integrated with plurality of data;
a extract transform and load (ETL) engine designed for extracting data from said Enterprise resource planning (ERP)/legacy engine consisting of business metrics relating to performance of the business with its organized data in hierarchy;
at least one LANDING PAD/staging layer having at least one staging data table;
at least one analytic engine called STAR SCHEMA designed for reporting, analysis and planning of information based on business metric implemented; and
at least one TRANSACTIONA DATA MODEL for transforming data from said Payor source into web interface;
Wherein said system provides useful information for making decision, managing business and predicting future plans.

2. The system of claim 1, wherein said plurality of data in Payor source as enterprise resource planning (ERP)/legacy engine includes but not limited to GL, CL (claims adjudication), PR (provider), ME (member), HR(health record), CC (Call center),CM (Care/Case Management), feeds and sources.

3. The system of claim 1, wherein said system provides business intelligence for healthcare industry.

4. The system of claim 1 wherein said system is an application for Payor in healthcare industry.

5. An analytics and data warehousing to allow business intelligence performance management of healthcare services and method, the method comprising:
generating a Payor source system as enterprise resource planning (ERP)/legacy engine integrated with plurality of data;
extracting data from said Payor source by a extract transform and load (ETL) engine;
populating at least one staging data table on landing pad/staging area with said data;
transforming data from said staging data table into STAR SCHEMA for analysis which include business performance metrics;
implementing metrics for analyzing in STAR SCHEMA;
supporting and analyzing to user on user front end via web interface with ad hoc reporting, data mining, predictive modeling, fraud analysis, efficacy of care trending, research, score care/dashboard, said star schema engine facilitating user independent definition and user generation of user defined query concepts; and
generating analysis and reports on user front end by web interface.

6. The method of claim 5, wherein said transforming data from said staging data table into said STAR SCHEMA further comprises the step of providing at least a partial de-normalization of said data.

7. The method of claim 5, wherein said step of supporting and analyzing ad hoc analysis and data mining from a web interface further comprises the step of permitting user defined query concepts of said business analytic performance metric.

8. The system of claim 5, wherein said transformation data model provides at least a partial denormalization of said data using star schema.

9. The method of claim 5, wherein data from enterprise resource planning (ERP)/legacy are transformed and analyzed and thereby displaced on web interface further comprises steps selected from the group consisting of:
performing transformation algorithms;
creating derived variables;
restructuring data;
updating analytic;
creating business performance metric;
and outputting information to a user through web interface based, in part, on the analysis.

10. A method for providing predictive modeling capabilities to allow intelligent business performance management of a business comprising the steps of:
generating, using at least one computer, ERP/LEGACY consisting of business metrics relating to performance of the business as a hierarchy across operational and strategic levels of the business with each;
a strategic level of the business comprising strategic metrics having a relationship with transsactional data model and star schema;
transforming, transformation data model, the data source into performance warehouse star schemas without losing persistence of historical data related to the performance of the business; and
using a computer, receiving requests for metric predictions and servicing the requests in real time.

11. The method of claim 10, wherein said STAR SCHEMA context to be used as input for business performance analysis.

12. The method of claim 10, wherein said method further comprises business metrics categorized within a predictive metric context to be used for predictive modeling.

13. The method of claim 10, wherein business intelligence performance management of healthcare services also includes receiving insurance claims data as input and predicting individual usage of healthcare services over a next insured period and predicting future plans.

14. The method of claim 10, wherein said method is further comprises steps selected from the group consisting of:
receiving a plurality of sets of data from Payor source;
matching at least one data from each set of the sets of data to each of a plurality business performance;
identifying a healthcare data from at least one of the sets of healthcare data records that is relevant to a target query;
analyzing the result of associating query; and
outputting information to user from web interface in part of the analysis.

15. The method of claim 11, further comprising allowing management of the target business of Payor industries on healthcare and wellbeing through processes.

16. The method of claim 11, wherein the step of allowing management comprises allowing viewing of financial, health care and administrative data for a target healthcare service and allowing capture of additional data and activities associated with that care.

17. The method of claim 11, wherein the data is at least one of a healthcare service, financial, and administrative data.

18. A business intelligence appliance, comprising:
hardware memory for storage; and
a processor coupled to the hardware memory, in which the processor is configured to execute the steps comprising: receiving a plurality of sets of healthcare data records; extracting data by ETL; matching at least one healthcare data record from each set of the sets of healthcare data; transforming data by transactional data model by using business metrics; identifying a healthcare data record from at least one of the sets of healthcare data that is relevant to a target; analyzing the result of associating each data of the plurality of data with at least one healthcare data from at least one set of healthcare data and the result of identifying the health care data relevant to the target data; and outputting information to web interface on user front area, in part, on the analysis.
